(19) United States
(12) Patent Application Publication
(10) Pub. No.: US 2025/0272447 A1
(43) Pub. Date: Aug. 28, 2025

(54) TRAINING SET GENERATION METHOD AND ELECTRONIC DEVICE

(71) Applicant: HON HAI PRECISION INDUSTRY CO., LTD., New Taipei (TW)

(72) Inventors: GUO-CHIN SUN, New Taipei (TW); CHIN-PIN KUO, New Taipei (TW); TZU-CHEN LIN, New Taipei (TW); I-HUA CHEN, New Taipei (TW); YUEH CHANG, New Taipei (TW); YI-FANG LEE, New Taipei (TW)

(21) Appl. No.: 18/738,007

(22) Filed: Jun. 8, 2024

(30) Foreign Application Priority Data
Feb. 27, 2024 (CN) 202410216009.X

(51) Int. Cl. G06F 30/15; B60W 50/06; G06F 30/27

(52) U.S. Cl. CPC G06F 30/15; B60W 50/06; G06F 30/27

(57) ABSTRACT

A training set generation method comprises generating simulated driving data based on an advanced driving assistance system (ADAS) simulator, inputting the simulated driving data into an objective generator to obtain generated data, wherein the objective generator is a generator trained by a generated adversarial network, and determining a model training set of an ADAS model based on the generated data. An electronic device is also disclosed.

### FIELD

The subject matter herein generally relates to driver assistance field.

### BACKGROUND

Many sensors are installed on a vehicle, an Advanced Driving Assistance System (ADAS) of the vehicle can sense surrounding environment information in real time by the sensors to identify, detect and track static obstacles and dynamic obstacles. The ADAS can also combine with navigation map data for systematic calculation and analysis, and a driver can detect possible danger in advance, comfort and safety of vehicle driving can be increased effectively.

Training devices can collect driving data of the vehicle, such as the driving data of the vehicle includes road images around the vehicle. The driving data of the vehicle can be training data of an ADAS model to train and verify the ADAS.

Due to limitations of climate and region, the training devices are inefficient to obtain training sets and are difficult to collect comprehensive road condition data around the vehicle. The ADAS model trained by the training devices cannot flexibly handle various road condition, driving safety is affected.

### BRIEF DESCRIPTION OF THE DRAWINGS

Implementations of the present disclosure will now be described, by way of embodiments, with reference to the attached figures.

FIG. 1 is a flowchart illustrating an embodiment of a training set generation method according to the present disclosure.

FIG. 2 is a flowchart illustrating another embodiment of a training set generation method according to the present disclosure.

FIG. 3 is a scene diagram showing an embodiment of training an objective generator according to the present disclosure.

FIG. 4 is a flowchart illustrating another embodiment of a training set generation method according to the present disclosure.

FIG. 5 is a scene diagram showing an embodiment of obtaining a model training set according to the present disclosure.

FIG. 6 is a diagram showing modules illustrating a vehicle.

FIG. 7 is a diagram showing an embodiment of a training set generation device according to the present disclosure.

FIG. 8 is a diagram showing an embodiment of an objective generator training device according to the present disclosure.

FIG. 9 is a diagram showing modules illustrating an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to;” it specifically indicates open-ended inclusion or membership in the so-described combination, group, series, and the like.

In some embodiments, simulators can be configured to simulate driving scenarios. For example, driving scene parameters are created in the simulators, such as the driving scene parameters include road condition parameters and climate parameters. When a user drives a vehicle using the ADAS model, the user is not satisfied with assistance effect of the ADAS model, and the user selects the driving scene parameters in the simulators. The simulators can simulate driving scene according to the selected driving scene parameters by the user to obtain training data. The training data is not limited by the climate and the region.

However, it is difficult to make simulated road condition parameters closer to real road condition parameters, the user may spend a lot of time adjusting simulation parameters in the simulator. Therefore, an efficiency of acquiring training data is low.

The driving scene parameters pre-stored in the simulator are limited. The actual driving scene parameters are flexible and changeable. The driving data of the vehicle in various driving scenes cannot be obtained.

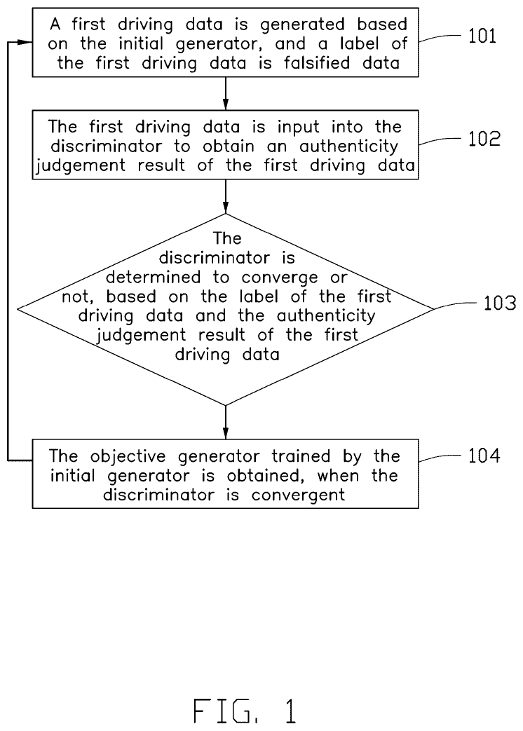

FIG. 1 illustrates a first embodiment of a training set generation method. The flowchart presents an exemplary embodiment of the method. The exemplary method is provided by way of example, as there are a variety of ways to carry out the method. Each block shown in FIG. 1 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

The training set generation method is trained to obtain an objective generator based on a Generative Adversarial Network (GAN). The generated adversarial network includes an initial generator and a discriminator. The objective generator is a trained initial generator. The objective generator can obtain generated data based on simulated driving data. The generated data can be used to determine a model training set of the ADAS model.

In block S100, a first driving data is generated based on the initial generator, and a label of the first driving data is falsified data.

In the embodiment, the first driving data can describe first road environment information forged by the initial generator, such as the first road environment information includes driving road image, surrounding obstacles, etc.

In some embodiments, the vehicle can be installed various sensors to obtain road environment information, the sensors include optical radars, cameras, etc. The initial generator can forge the first road environment information monitored by various sensors as the first driving data.

The first driving data also includes forged vehicle motion parameters, the vehicle motion parameters include vehicle speed, vehicle acceleration, and driving direction of the vehicle.

In one embodiment, random noise data is obtained, and the random noise data is input into the initial generator to generate the first driving data.

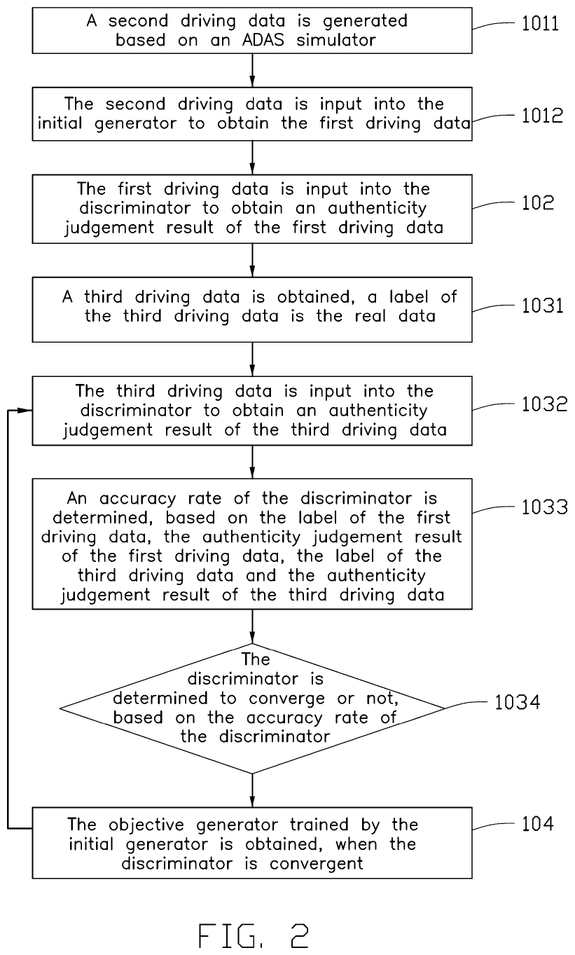

In some embodiments, please refer to FIG. 2, the block S100 includes some blocks.

In block S1011, a second driving data is generated based on an ADAS simulator.

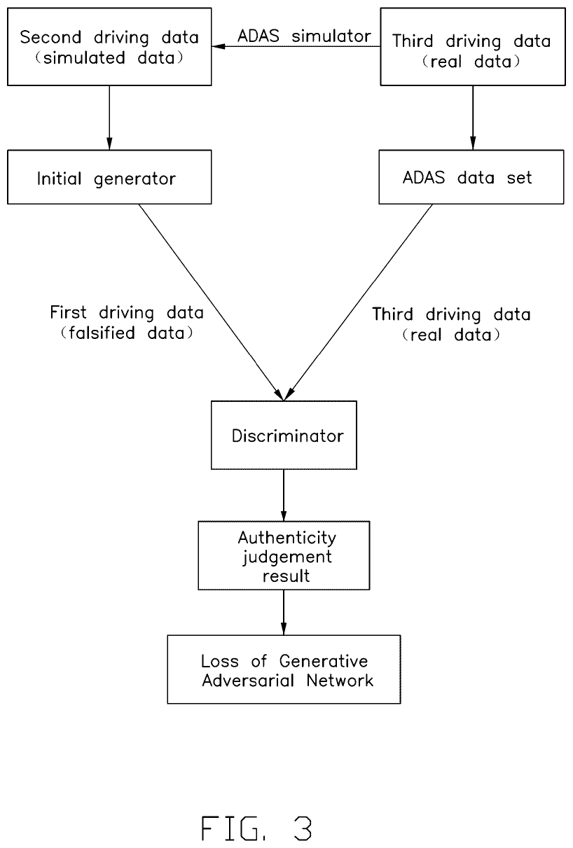

In one embodiment, the ADAS simulator can be configured based on existing ADAS datasets. Please refer to FIG. 3, the existing ADAS datasets store real data, the real data includes real driving data collected by sensors in the vehicle and/or data in publicly data in the existing ADAS datasets.

The second driving data describes a second road environment information simulated by the ADAS simulator, the second road environment information includes the driving road image, the surrounding obstacles, etc. The second driving data also includes the simulated vehicle motion parameters, such as the vehicle speed, the vehicle acceleration, and the driving direction of the vehicle.

In block S1012, the second driving data is input into the initial generator to obtain the first driving data.

In one embodiment, the second driving data is taken as an input of the discriminator. On the one hand, the generator can conveniently learn difference between the second driving data and the first driving data. On the other hand, training efficiency of the generator can be improved.

In block S102, the first driving data is input into the discriminator to obtain an authenticity judgment result of the first driving data.

In one embodiment, after the first driving data is input into the discriminator, the discriminator can determine whether the first driving data is the real data or the falsified data to obtain the authenticity judgment result of the first driving data.

In block S103, the discriminator is determined to converge or not, based on the label of the first driving data and the authenticity judgment result of the first driving data.

In some embodiments, an accuracy rate of the discriminator for authenticity judgment can be determined, based on the label of the first driving data and the authenticity judgment result of the first driving data. For example, if the authenticity judgment result of the first driving data is the falsified data, a result of the discriminator for the authenticity judgment is correct. If the authenticity judgment result of the first driving data is the real data, the result of the discriminator for the authenticity judgment is wrong. The discriminator is determined to converge or not based on the accuracy rate of the discriminator for the authenticity judgment.

In one embodiment, if the accuracy rate of the discriminator for the authenticity judgment exceeds a preset threshold, the discriminator is stable, and the discriminator is convergent. If the accuracy rate of the discriminator for the authenticity judgment is less than the preset threshold, the discriminator is not convergent.

The preset threshold can be set according to actual application requirements, for example, the preset threshold can be set to 0.5, or fluctuate around 0.5.

In some embodiments, the block S103 also includes some blocks.

In block S1031, a third driving data is obtained, a label of the third driving data is the real data.

The third driving data is a third road condition environment information, the third road condition environment information is the real data collected by the sensors.

Please refer to FIG. 3, the third driving data can be derived from the existing ADAS datasets.

In some embodiments, the third driving data also includes real vehicle motion parameters, such as real vehicle speed, real vehicle acceleration, and real driving direction of the vehicle.

In block S1032, the third driving data is input into the discriminator to obtain an authenticity judgment result of the third driving data.

In one embodiment, after the third driving data is input into the discriminator, the discriminator can determine whether the third driving data is the real data or the falsified data to obtain the authenticity judgment result of the third driving data.

In block S1033, an accuracy rate of the discriminator is determined, based on the label of the first driving data, the authenticity judgment result of the first driving data, the label of the third driving data and the authenticity judgment result of the third driving data.

For example, if the authenticity judgment result of the first driving data is the falsified data, the authenticity judgment result of the first driving data is consistent with the label of the first driving data, the result of the discriminator for the authenticity judgment is correct. If the authenticity judgment result of the first driving data is the real data, the authenticity judgment result of the first driving data is not consistent with the label of the first driving data, the result of the discriminator for the authenticity judgment is wrong.

If the authenticity judgment result of the third driving data is the falsified data, the authenticity judgment result of the third driving data is consistent with the label of the third driving data, the result of the discriminator for the authenticity judgment is correct. If the authenticity judgment result of the third driving data is the real data, the authenticity judgment result of the third driving data is not consistent with the label of the third driving data, the result of the discriminator for the authenticity judgment is wrong.

The accuracy rate of the discriminator is determined, based on an authenticity judgment result of the discriminator.

In block S1034, the discriminator is determined to converge or not, based on the accuracy rate of the discriminator.

If the discriminator is convergent, the GAN was completed, and block S104 is executed. If the discriminator is not convergent, the initial generator and the discriminator are trained based on the GAN. For example, after some model parameters are updated in the initial generator, and block S101 is executed again.

In block S104, the objective generator trained by the initial generator is obtained, when the discriminator is convergent.

In some embodiments, the initial generator is the objective generator. The objective generator obtains the generated data and determines the model training set of the ADAS model. The generated data includes the generated driving road images, etc.

For example, the objective generator can obtain the generated data based on the simulated driving data. The simulated driving data is generated by the ADAS simulator, and the generated data is taken as data in the model training set of the ADAS model.

In the embodiment, the initial generator in the generated adversarial network is trained by the existing ADAS datasets. The initial generator can learn differences between the second driving data (the simulated driving data) and the first driving data (the real driving data) to obtain the objective generator.

Then, the objective generator is combined with the ADAS simulator to generate a large number of the generated data which are close to the real road environment information. The model training set of the ADAS model is obtained based on the generated data, optimization difficulty of the simulation parameter of the simulator is greatly reduced, amounts of data collected by the sensors in the vehicle is also reduced, and the model training set includes the driving data of various road conditions.

The first embodiment provides the training set generation method, a second embodiment of the application provides another training set generation method. The training set generation method can use the objective generator trained by the training set generation method in the first embodiment to obtain the generated data, and the model training set of the ADAS model can be determined based on the generated data.

In one embodiment, the training set generation method in the second embodiment and the training set generation method in the first embodiment can be executed in a same electronic device or in different electronic devices.

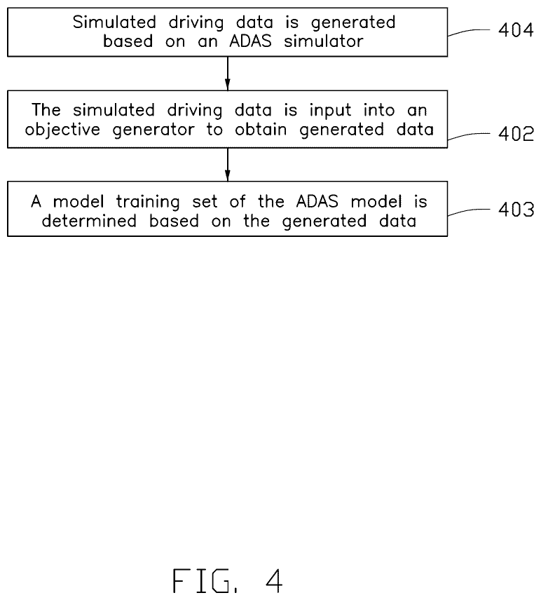

Please refer to FIG. 4, FIG. 4 illustrates the second embodiment of a training set generation method.

In block S401, simulated driving data is generated based on the ADAS simulator.

The ADAS simulator in the second embodiment and the ADAS simulator in the first embodiment can be a same simulator.

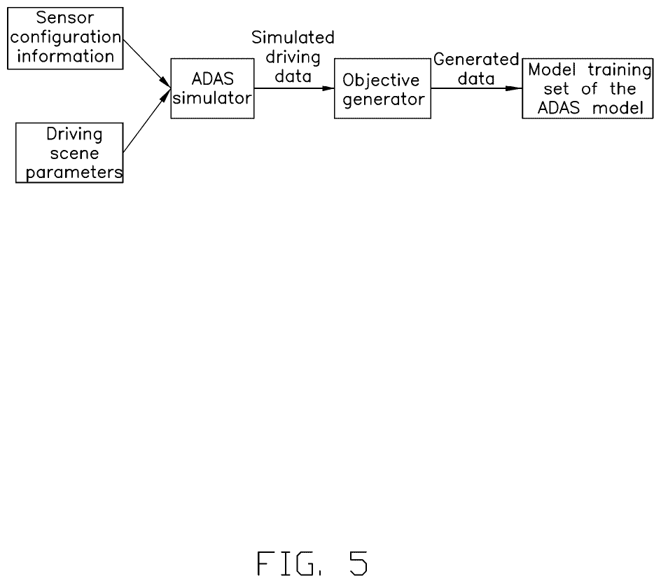

In some embodiments, please refer to FIG. 5, block S410 can include some blocks. Driving scenario parameters for training the ADAS model is obtained and the driving scenario parameters are input into the ADAS simulator to obtain the simulated driving data. The driving scenario parameters of the ADAS model are not trained by the ADAS simulator.

The driving scenario parameters of the ADAS model include climate information, such as rainy, sunny, light information, a curvature of the driving data, surrounding obstacles, lane information. The driving scenario parameters of the ADAS model can be configured based on training requirements.

The ADAS simulator can also obtain sensor configuration information in a vehicle. The sensor configuration information can describe sensors installed in the vehicle. The simulation driving data is obtained based on the sensor configuration information and the driving scene parameters.

The ADAS simulator can simulate driving data collected by objective sensors in the driving scene parameters, and the driving data is the simulation driving data. The objective sensors are sensors installed in the vehicle based on the sensor configuration information.

In block S402, the simulated driving data is input into the objective generator to obtain generated data.

In some embodiments, the objective generator is a generator trained by the generated adversarial network. The generated adversarial network includes the initial generator and the discriminator. Blocks of training the objective generator include: generating the first driving data based on the initial generator, inputting the first driving data into the discriminator to obtain the authenticity judgment result of the first driving data, determining whether the discriminator is convergent, based on the label of the first driving data and the authenticity judgment result of the first driving data, and obtaining the objective generator trained by the initial generator when the discriminator is convergent. The label of the first driving data is the falsified data.

In some embodiments, the second driving data is generated based on the ADAS simulator, and the second driving data is input into the initial generator to obtain the first driving data.

In some embodiments, the third driving data is obtained, wherein the label of the third driving data is the real data, the third driving data is input into the discriminator to obtain the authenticity judgment result of the third driving data, the accuracy rate of the discriminator is determined based on the label of the first driving data, the authenticity judgment result of the first driving data, the label of the third driving data and the authenticity judgment result of the third driving data. The discriminator is determined to converge or not based on the accuracy rate of the discriminator.

The training set generation method can refer to implementation details of the first embodiment in block S101 to block S104 shown in FIG. 1 or in block S1011 to block S104 shown in FIG. 2.

In block S403, the model training set of the ADAS model is determined based on the generated data.

In some embodiments, the electronic device can add the generated data to the model training set of the ADAS model as the training data of the model training set.

The objective generator is combined with the simulator to simulate the real environment, and the simulated driving data is obtained. The difference between the simulated driving data and the real driving data can be obtained, based on the generator trained by the generative adversarial network. The generated data obtained by the simulated driving data can be close to the real driving data, optimization steps of the simulation parameters in the simulator are drastically reduced.

The model training set of the ADAS model is obtained based on the generated data, training data reflecting various road conditions can be obtained, under a condition of reducing collection amount of the real driving data. Driving assistance performance of the ADAS model and acquisition efficiency of training set are improved.

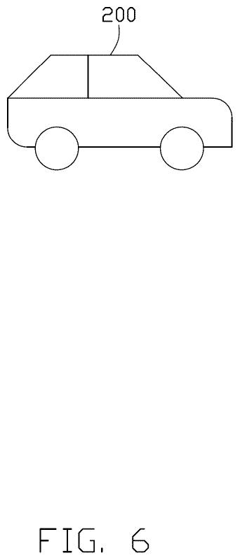

In one embodiment, please refer to FIG. 6, after the model training set of the ADAS model is determined based on the generated data, a driving assistance plan is generated to drive the vehicle 200 based on the ADAS model trained by the model training set in respond to receiving a vehicle driving assistance request.

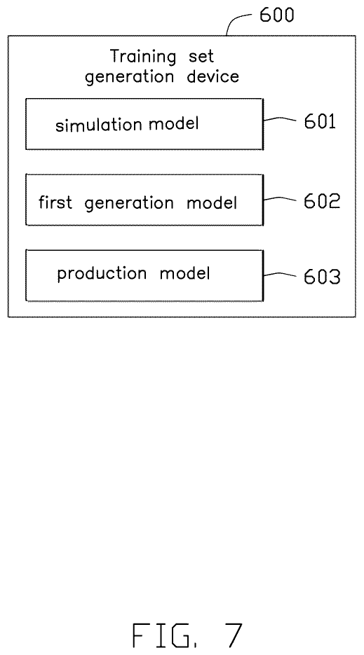

Please refer to FIG. 7, FIG. 7 shows the training set generation device 600. The training set generation device 600 includes a simulation model 601, a first generation model 602 and a production model 603. The simulation model 601 generates the simulated driving data based on the ADAS simulator. The first generation model 602 inputs the simulated driving data into the objective generator to obtain the generated data, the objective generator is the generator trained by the generated adversarial network. The production model 603 determines the model training set of the ADAS model based on the generated data.

In one embodiment, the simulation model 601 obtains the driving scenario parameters for training the ADAS model, the driving scenario parameters is not trained by the ADAS simulator. the simulation model 601 inputs the driving scenario parameters into the ADAS simulator to obtain the simulated driving data.

In some embodiments, the generated adversarial network includes the initial generator and the discriminator. The training set generation device 600 further includes a training device. The training device generates the first driving data based on the initial generator, the label of the first driving data is falsified data. The training device inputs the first driving data into the discriminator to obtain the authenticity judgment result of the first driving data. The training device determines whether the discriminator is convergent, based on the label of the first driving data and the authenticity judgment result of the first driving data. The training device obtains the objective generator trained by the initial generator when the discriminator is convergent.

In some embodiments, the training device further generates the second driving data based on the ADAS simulator and inputs the second driving data into the initial generator to obtain the first driving data.

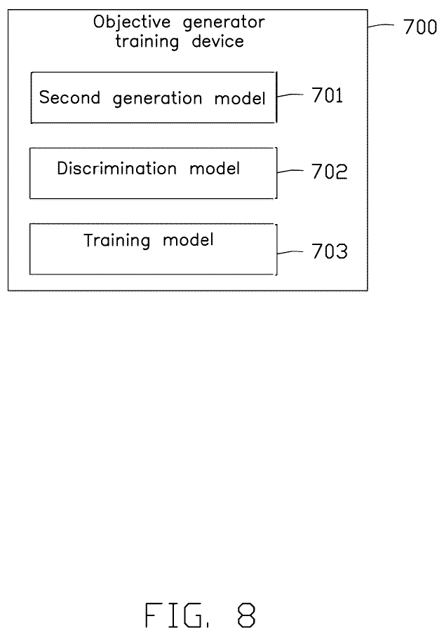

As shown in FIG. 8, FIG. 8 shows an objective generator training device 700. The objective generator training device 700 includes a second generation model 701, a discrimination model 702 and a training model 703.

In one embodiment, the second generation model 701 generates the first driving data based on the initial generator, the label of the first driving data is falsified data. The discrimination model 702 inputs the first driving data into the discriminator to obtain the authenticity judgment result of the first driving data. The training model 703 determines whether the discriminator is convergent, based on the label of the first driving data and the authenticity judgment result of the first driving data. The training model 703 obtains the objective generator trained by the initial generator when the discriminator is convergent.

The second generation model 701 also generates the second driving data based on the ADAS simulator and inputs the second driving data into the initial generator to obtain the first driving data.

In some embodiments, the discrimination model 702 obtains the third driving data, the label of the third driving data is the real data. The discrimination model 702 inputs the third driving data into the discriminator to obtain the authenticity judgment result of the third driving data. The discrimination model 702 determines the accuracy rate of the discriminator, based on the label of the first driving data, the authenticity judgment result of the first driving data, the label of the third driving data and the authenticity judgment result of the third driving data. The discrimination model 702 determines whether the discriminator is convergent based on the accuracy rate of the discriminator.

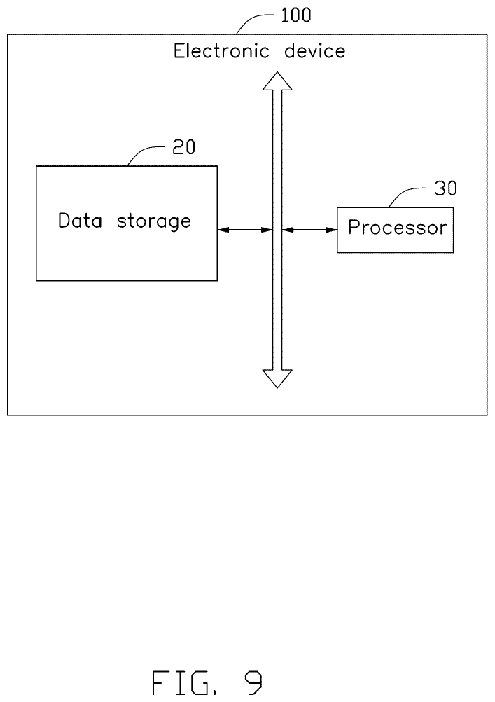

As shown in FIG. 9, one exemplary embodiment of an electronic device 100 comprises at least one processor 30 and a data storage 20. The data storage 20 stores one or more programs which can be executed by the at least one processor 30. The data storage 20 is used to store instructions, and the processor 30 is used to call up instructions from the data storage 20, so that the electronic device 100 performs the steps of the training set generation method in the above embodiment.

In one embodiment, a non-transitory storage medium recording instructions is disclosed. When the recorded computer instructions are executed by a processor of an electronic device 100, the electronic device 100 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A training set generation method comprising:
generating simulated driving data based on an advanced driving assistance system (ADAS) simulator;
inputting the simulated driving data into an objective generator to obtain generated data, wherein the objective generator is a generator trained by a generated adversarial network; and
determining a model training set of an ADAS model based on the generated data.

2. The training set generation method of claim 1, wherein generating simulated driving data based on the ADAS simulator comprises:
obtaining driving scenario parameters for training the ADAS model;
inputting the driving scenario parameters into the ADAS simulator to obtain the simulated driving data.

3. The training set generation method of claim 1, wherein the generated adversarial network comprises an initial generator and a discriminator; the objective generator is trained by:
generating a first driving data based on the initial generator, wherein a label of the first driving data is falsified data;
inputting the first driving data into the discriminator to obtain an authenticity judgment result of the first driving data;
determining whether the discriminator is convergent, based on the label of the first driving data and the authenticity judgment result of the first driving data; and
obtaining the objective generator trained by the initial generator when the discriminator is convergent.

4. The training set generation method of claim 2, wherein the generated adversarial network comprises an initial generator and a discriminator; the objective generator is trained by:
generating a first driving data based on the initial generator, wherein a label of the first driving data is falsified data;
inputting the first driving data into the discriminator to obtain an authenticity judgment result of the first driving data;
determining whether the discriminator is convergent, based on the label of the first driving data and the authenticity judgment result of the first driving data; and
obtaining the objective generator trained by the initial generator when the discriminator is convergent.

5. The training set generation method of claim 3, wherein generating the first driving data based on the initial generator comprises:
generating a second driving data based on the ADAS simulator; and
inputting the second driving data into the initial generator to obtain the first driving data.

6. The training set generation method of claim 4, wherein generating the first driving data based on the initial generator comprises:
generating a second driving data based on the ADAS simulator; and
inputting the second driving data into the initial generator to obtain the first driving data.

7. The training set generation method of claim 1, wherein after determining the model training set of the ADAS model based on the generated data comprises:
generating a driving assistance plan to drive a vehicle based on the ADAS model trained by the model training set in respond to receiving a vehicle driving assistance request.

8. A training set generation method comprising:
generating simulated driving data based on an advanced driving assistance system (ADAS) simulator;
generating a first driving data based on an initial generator of a generated adversarial network, wherein a label of the first driving data is falsified data;
inputting the first driving data into a discriminator of the generated adversarial network to obtain an authenticity judgment result of the first driving data;
determining whether the discriminator is convergent, based on the label of the first driving data and the authenticity judgment result of the first driving data; and
obtaining an objective generator trained by the initial generator when the discriminator is convergent;
inputting the simulated driving data into the objective generator to obtain generated data; and
determining a model training set of an ADAS model based on the generated data.

9. The training set generation method of claim 8, wherein generating the first driving data based on the initial generator comprises:
generating a second driving data based on the ADAS simulator; and
inputting the second driving data into the initial generator to obtain the first driving data.

10. The training set generation method of claim 8, wherein determining whether the discriminator is convergent based on the label of the first driving data and the authenticity judgment result of the first driving data comprises:
obtaining a third driving data, wherein a label of the third driving data is real data;
inputting the third driving data into the discriminator to obtain an authenticity judgment result of the third driving data;
determining an accuracy rate of the discriminator, based on the label of the first driving data, the authenticity judgment result of the first driving data, the label of the third driving data and the authenticity judgment result of the third driving data; and
determining whether the discriminator is convergent based on the accuracy rate of the discriminator.

11. The training set generation method of claim 8, wherein after determining the model training set of the ADAS model based on the generated data comprises:
generating a driving assistance plan to drive a vehicle based on the ADAS model trained by the model training set in respond to receiving a vehicle driving assistance request.

12. An electronic device, comprising:
at least one processor; and
a data storage storing one or more programs which when executed by the at least one processor, cause the at least one processor to:
generate simulated driving data based on an advanced driving assistance system (ADAS) simulator;
input the simulated driving data into an objective generator to obtain generated data, wherein the objective generator is a generator trained by a generated adversarial network; and
determine a model training set of an ADAS model based on the generated data.

13. The electronic device of claim 12, wherein the at least one processor generates simulated driving data based on the ADAS simulator, the at least one processor is further caused to:
obtain driving scenario parameters for training the ADAS model;
input the driving scenario parameters into the ADAS simulator to obtain the simulated driving data.

14. The electronic device of claim 12, wherein the generated adversarial network comprises an initial generator and a discriminator; the objective generator is trained by:
generating a first driving data based on the initial generator, wherein a label of the first driving data is falsified data;
inputting the first driving data into the discriminator to obtain an authenticity judgment result of the first driving data;
determining whether the discriminator is convergent, based on the label of the first driving data and the authenticity judgment result of the first driving data; and
obtaining the objective generator trained by the initial generator when the discriminator is convergent.

15. The electronic device of claim 13, wherein the generated adversarial network comprises an initial generator and a discriminator; the objective generator is trained by:
generating a first driving data based on the initial generator, wherein a label of the first driving data is falsified data;
inputting the first driving data into the discriminator to obtain an authenticity judgment result of the first driving data;
determining whether the discriminator is convergent, based on the label of the first driving data and the authenticity judgment result of the first driving data; and
obtaining the objective generator trained by the initial generator, when the discriminator convergent.

16. The electronic device of claim 14, wherein the at least one processor generates the first driving data based on the initial generator, the at least one processor is further caused to:
generate a second driving data based on the ADAS simulator; and
input the second driving data into the initial generator to obtain the first driving data.

17. The electronic device of claim 15, wherein the at least one processor generates the first driving data based on the initial generator, the at least one processor is further caused to:
generate a second driving data based on the ADAS simulator; and
input the second driving data into the initial generator to obtain the first driving data.

18. The electronic device of claim 12, wherein after the at least one processor determines the model training set of the ADAS model based on the generated data is caused to:
generate a driving assistance plan to drive a vehicle based on the ADAS model trained by the model training set in respond to receiving a vehicle driving assistance request.
